(19) United States
(12) Patent Application Publication
(10) Pub. No.: US 2024/0355313 A1
(43) Pub. Date: Oct. 24, 2024

(54) BATHROOM PRIVACY SOUND SYSTEM

(71) Applicant: Ascent Holdings, LLC, Gig Harbor, WA (US)

(72) Inventor: Tony J. Branham, Gig Harbor, WA (US)

(21) Appl. No.: 18/633,220

(22) Filed: Apr. 11, 2024

Related U.S. Application Data
(60) Provisional application No. 63/497,110, filed on Apr. 19, 2023.

(51) Int. Cl. G10K 11/175; E03D 9/04; H04R 1/02

(52) U.S. Cl. CPC G10K 11/1752; E03D 9/04; H04R 1/028

(57) ABSTRACT

A system and device that produces artificial sounds at frequencies that have been specifically designed to mask the frequency of noises that emanate from use of a toilet, bidet, or urinal, the system and device including a processor mounted in a housing and controllable via a switch on the exterior of the housing, and may include a variable timer and a ventilation fan, the processor having executable instructions for generating sound or sounds emitted within the range of human hearing and at selected frequencies to mask selected sounds that emanate from use of a toilet, bidet, or urinal.

### BACKGROUND

### Technical Field

The present disclosure is directed to noise cancelling and, more particularly, to a device that generates a simulated fan sound to provide a level of privacy noise in a bathroom.

### Description of the Related Art

There are various existing devices that aim to reduce or conceal noises arising from bathroom activity, thereby giving more privacy to a person using the bathroom. Some of these devices employ noisemakers that are triggered upon a specific action. For example, the machine of U.S. Patent Pub. No. 2007/0132596 ('596 application) includes a detector that detects the change in position of the toilet lid. When the toilet lid is opened, the detector sends a signal to a receiver that activates a sound maker, which produces noise to drown out the ensuing bathroom noises. A similar solution is found in U.S. Pat. No. 6,992,570, which describes a public restroom cubicle having a privacy noisemaker that activates upon sensing that a person has entered the cubicle. Activation may be triggered in a variety of ways including using a motion sensor, weight sensor, or electrical connection that detects when the door and door latch are in contact. Other solutions are activated manually. A different approach is provided in U.S. Pat. No. 5,499,008, which describes a sound system that can be mounted on the wall of a bathroom and that produces noise upon the depression of a button on the housing of the system.

Existing solutions allow users to select different volumes and types of noises. The descriptions in the'596 application and the '008 patent, for example, both allow for sound to be emitted in the form of music, rain, and ocean waves. However, by relying on choices of the user regarding sound type and volume, these devices are not designed for the best sound producing effect. It would be advantageous to have a sound producing device that emits sound optimized specifically to conceal the range of noises that may be made in a bathroom.

### BRIEF SUMMARY

The present disclosure is directed to a system, method, and a device for producing artificial sounds to mask noises emanating from the use of a toilet, bidet, or urinal that addresses the foregoing deficiencies in bathroom noise generating devices.

In accordance with one aspect of the present disclosure, a system for producing artificial sounds to mask noises emanating from the use of a toilet in an interior of a room is provided. The system includes a housing sized and shaped to define an interior and an exterior of the housing, and a sound system stored within the housing, the sound system comprising a processor, the processor having a memory that has stored therein a set of instructions executable by the processor to generate a sound structured to mask frequencies of noise associated with use of the toilet.

In accordance with another aspect of the present disclosure, the system includes a cover that forms a wall of the housing and a switch that can be toggled by a user to activate the sound system.

In accordance with yet another aspect of the present disclosure, the system includes at least one opening in the cover that is sized and shaped to enable sound to be emitted from the housing.

In accordance with still another aspect of the present disclosure, the processor includes a variable timer adapted to control the duration of the sound emitted from the sound system, and the variable timer is adapted to allow the user to select the duration of the sound.

In accordance with a further aspect of the present disclosure, the sound generated by the processor is structured to mask the noises emanating from the use of the toilet in the range of human hearing.

In accordance with yet another aspect of the present disclosure, a system for producing artificial sounds to mask noises emanating from use of a toilet in a bathroom having a wall and a ceiling is provided. The system includes a housing structured to mount to the wall of the bathroom, means for storing a set of instructions with the storing means contained in the housing, and means for producing sound contained in the housing and coupled to the storing means with the sound producing means structured to generate a sound that is capable of substantially masking frequencies of noise associated with use of the toilet.

In accordance with a further aspect of the present disclosure, a system for producing artificial sounds to mask noises associated with use of a toilet located in the interior of a room having a wall is provided. The system includes a device having a housing sized and shaped to be mounted on or within the wall, an interior of the housing formed by at least five housing walls and a cover, the cover sized and shaped to releasably engage with the housing, a switch mounted in the housing, a sound system located within the housing and coupled to the switch, the sound system adapted to produce a sound capable of substantially masking the noises associated with use of the toilet in the range of human hearing, and at least one opening formed in the cover that communicates with the interior of the housing and the interior of the room to allow the sound to be emitted from the housing.

In accordance with still yet another aspect of the present disclosure, a ventilation system for ventilating a room having a toilet is provided. The ventilation system includes means for ventilating the room, a device for producing artificial sounds to mask noises associated with use of a toilet located in an interior of a room having a wall, the device including a housing sized and shaped to be mounted on or within the wall, an interior of the housing being formed by at least five housing walls and a cover, the cover sized and shaped to releasably engage with the housing, a switch mounted in the housing, a sound system located within the housing and coupled to the switch, the sound system adapted to produce a sound capable of substantially masking the noises associated with use of the toilet in the range of human hearing, and at least one opening formed in the cover that communicates with the interior of the housing and the interior of the room to allow the sound to be emitted from the housing.

In accordance with another aspect of the present disclosure, a ventilation system for ventilating a room having a toilet is provided. The ventilation system includes means for ventilating the room, a system for producing artificial sounds to mask noises associated with use of a toilet located in an room having a wall, the system including a housing sized and shaped to be mounted on or within the wall, an interior of the housing being formed by at least five housing walls and a cover, the cover sized and shaped to releasably engage with the housing, a switch mounted in the housing, a sound system located within the housing and coupled to the switch, the sound system having a processor with a memory that stores a set of instructions executable by the processor to produce sounds capable of substantially masking the noises associated with use of the toilet in the range of human hearing, and at least one speaker located within the means for ventilating the room and coupled to the sound system to amplify the sound encoded by the set of instructions.

### BRIEF DESCRIPTION OF THE SEVERAL VIEWS OF THE DRAWINGS

The foregoing features and advantages of the present disclosure will be more readily appreciated as the same become better understood from the following detailed description when taken in conjunction with the accompanying drawings, wherein:

FIG. 1 is an illustration of a room containing a toilet and a sound system for generating artificial noises to mask noises associated with use of a toilet.

FIG. 2 is an axonometric illustration of the front of the sound system.

FIG. 3 is an axonometric illustration of the back of the sound system.

FIG. 4 is an illustration of the sound system with the cover removed, showing the interior of the sound system.

FIG. 5 is a block diagram illustrating the operation of the sound generator located within the sound system.

FIG. 6 is a bottom, right, front axonometric view of a fan box and ventilation system that can be used in combination with the sound system.

FIG. 7 is an axonometric illustration of a shield that can be removably attached to the ventilation system to block the fan from view.

FIG. 8 is a graph showing the frequencies masked by the sound produced by the sound system, the frequencies overlaid with the frequencies of multiple noises associated with the use of the bathroom.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components or both associated with the manufacture of toilets, urinals, bidets, as well as ventilation fans, blowers, ducting, and related controls have not been shown or described in order to avoid unnecessarily obscuring descriptions of the representative implementations herein below.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

The various implementations described above can be combined to provide further implementations. Aspects of the implementations can be modified, if necessary to employ concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

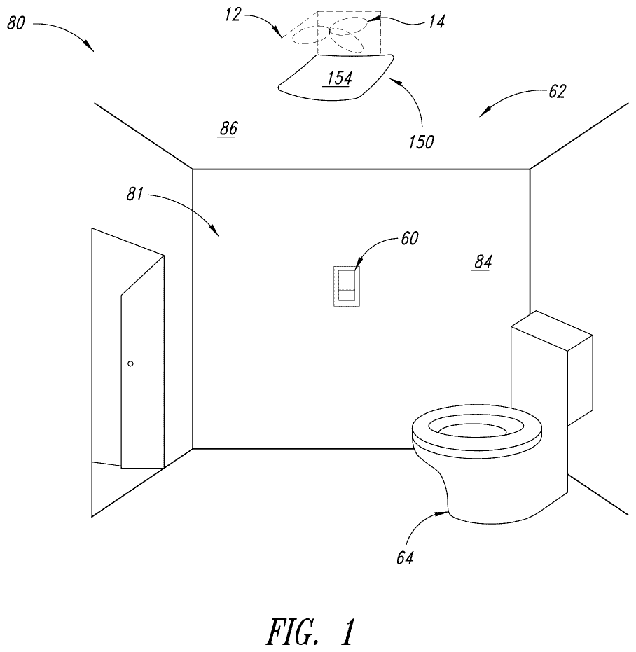

Referring initially to FIG. 1, shown therein is a system 60 for producing artificial sounds 28 to mask noises 82 associated with the use of a toilet 64. The system 60 may also be used to mask noises 82 associated with the use of a bidet (not shown) or urinal (not shown). Accordingly, the system 60 can be used in an interior 81 of a room 80 having a toilet 64, bidet, or urinal. The room 80 can be a room in a structure built on the ground or a room contained in a vehicle or craft, such as a motorhome, trailer, boat, aircraft, space craft, and other known structures.

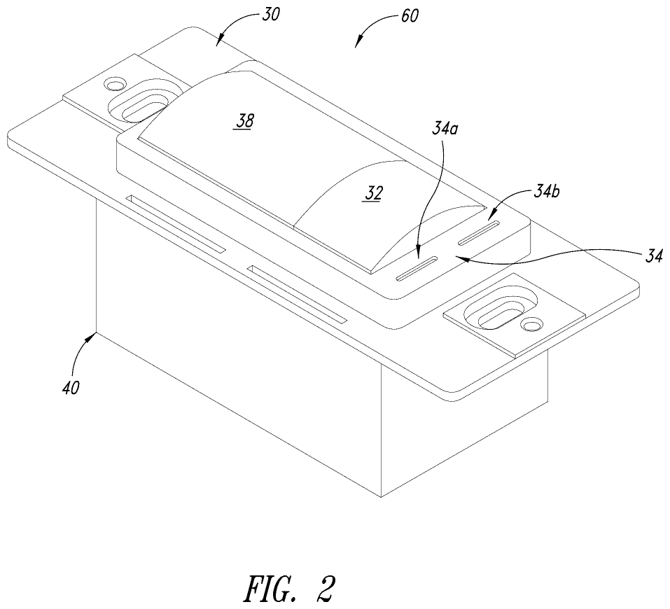

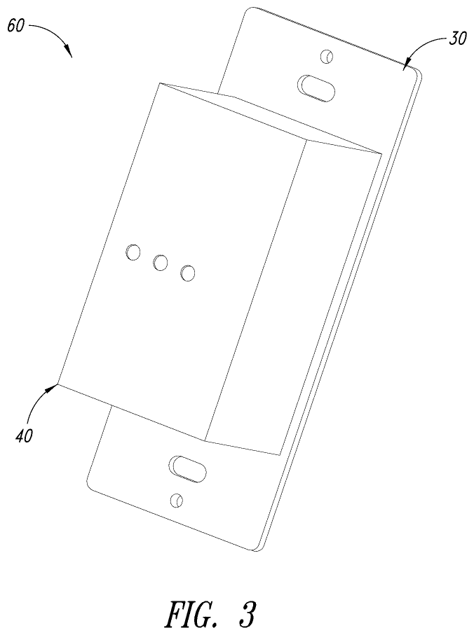

The system 60 is either surface or interior mounted in a ceiling 86 or a wall 84 of the room 80. Referring to FIGS. 2-5, the system 60 includes a housing 40 that contains a sound generator 20 composed of a processor 22. The processor 22 stores a set of instructions 26 in a memory 24 that are executable by the processor 22 to transmit a noise signal 27 to the one or more speakers 98 that then emit the artificial sounds 28. The artificial sounds 28 are structured to mask the frequencies 88 of noise 82 associated with the use of the toilet 64. For example, such noises 82 associated with the use of a toilet 64 may include toilet flushing, discharging bodily fluids and solids, gasses, running water, and showering.

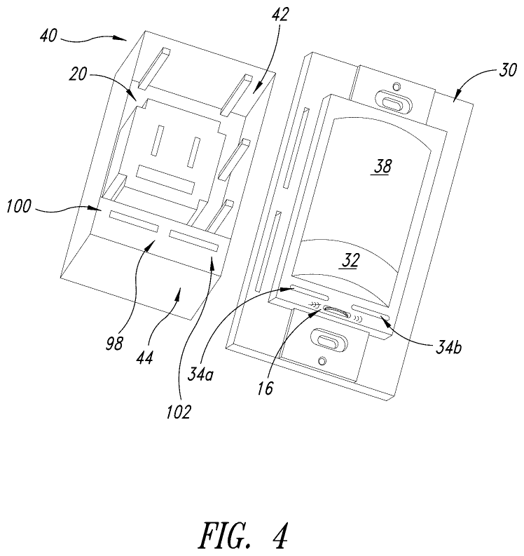

The housing 40, which may be designed for new construction or remodel construction, includes a removable cover 30 that is sized and shaped to cover an interior of the housing 42. The cover 30 can releasably engage with the housing 40, such as with a fastener, or an interference fit, secured with detents, or other known structures. A privacy switch 32 is configured to be mounted on the cover 30 and is structured to be activated, such as by toggling, by a user to activate the sound generator 20. In one implementation, the system 60 includes one or more openings 34 in the cover 30 to enable the artificial sound 28 to be emitted from the housing 40 and into the room 80. Preferably, the cover 30 contains two openings 34 such that the artificial sound 28 is emitted at different locations, giving depth to the artificial sounds 28 emitted into the room 80. As shown in FIG. 4, the sound generator 20 may be coupled to two speakers 98, a first speaker 100 that is structured to emit artificial sounds 28 substantially from a first opening 34a in the cover 30 and a second speaker 102 that is structured to emit artificial sounds 28 substantially from a second opening 34b in the cover 30.

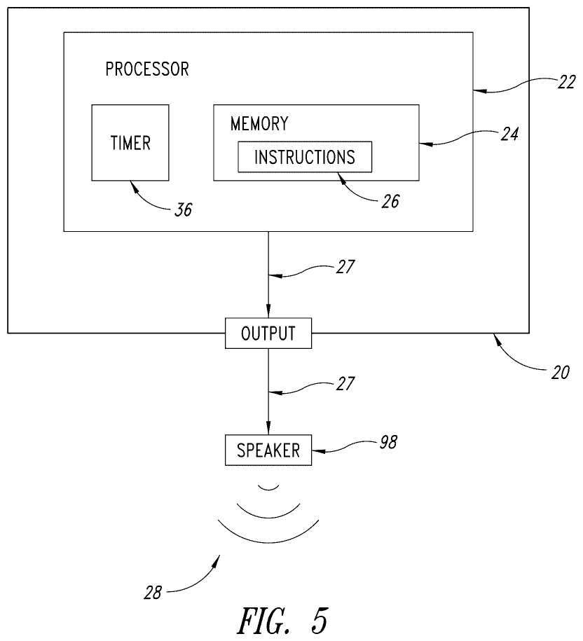

As shown in FIG. 5, the processor 22 may further include a variable timer 36 adapted to control the duration of the artificial sound 28 emitted from the sound generator 20. The artificial sounds 28 generated by the processor 22 are, in some implementations, specifically designed to be in the range of human hearing.

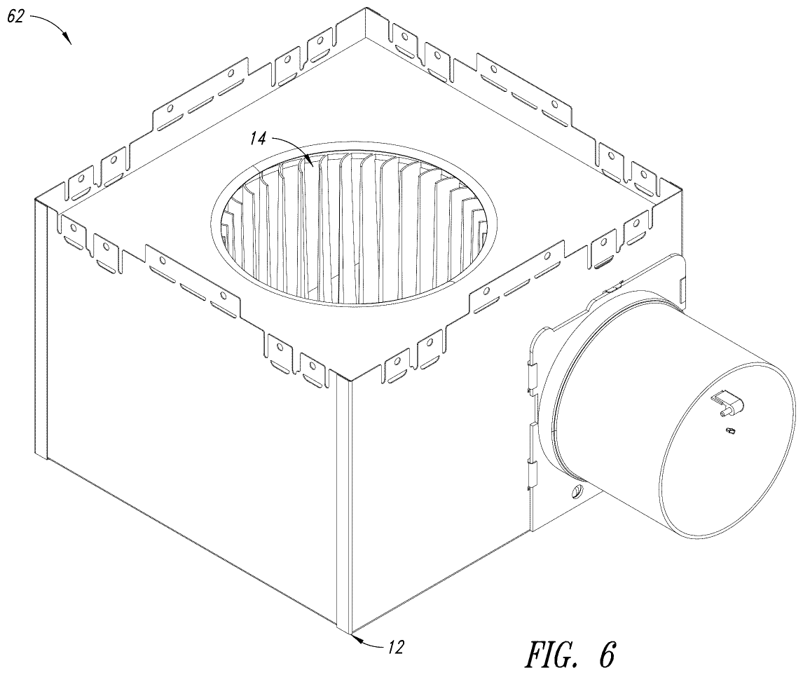

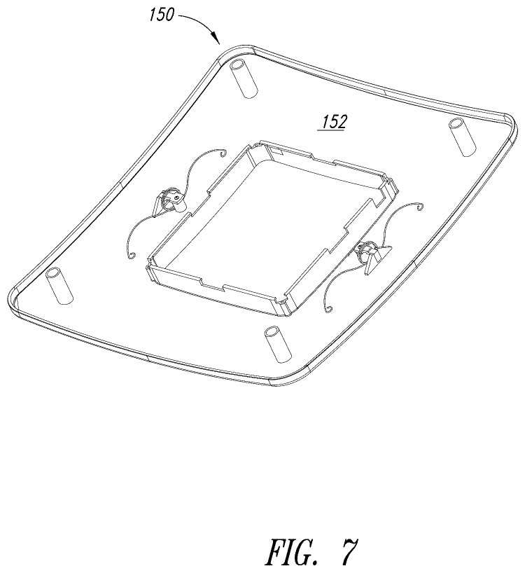

In one implementation, the system 60 is used in connection with a ventilation system 62 shown in FIG. 6 for ventilating the room 80. The ventilation system 62 includes a fan 14 inside a housing or fan box 12 that can be mounted to the ceiling 86 or wall 84. The ventilation system 62 may also include a shield 150, shown in FIG. 7, that can be attached to the fan box 12 or to the ceiling 86 to substantially block the fan box 12 from view. The shield 150 may be removably attached to the fan box 12 or ceiling 86 using an interference fit, springs, clips, or other known structures. The shield 150 has an interior surface 152 that faces the fan box 12 and an exterior surface 154 that faces the interior of the room. The ventilation system 62 is activated by a fan switch 38 mounted on the cover 30, and the fan switch 38 may be adjacent to the privacy switch 32. Having two switches 32, 38 allows the user to selectively activate the ventilation system 62 apart from the sound generator 20. Thus, a user may activate the ventilation system 62 and system 60 independently of each other or there may be a single switch that activates both the ventilation system 62 and the sound generator 20 concurrently. The fan 14 and ventilation system 62 may be coupled to the variable timer 36 such that, when the fan switch 38 is pressed, the fan 14 and ventilation system 62 are activated simultaneously for a predetermined period, for example, thirty minutes. In another implementation, the housing 40, cover 30, privacy switch 32, and fan switch 38 are mountable on a wall 84 and the artificial sound 28 is emitted from the fan box 12. Specifically, in this implementation, the one or more speakers 98 are located in the fan box 12, or on the interior surface 152 or exterior surface 154 of the shield 150. However, in other implementations, the one or more speakers 98 are in the housing 40.

In one implementation, the privacy switch 32 and fan switch 38, as shown in FIG. 2, operate as follows: When the fan switch 38 is pressed, the fan 14 and ventilation system 62 are activated for a period of thirty minutes, as determined by the variable timer 36. When the fan switch 32 is pressed again, the fan 14, ventilation system 62, and variable timer 36 are turned off. When the privacy switch 32 is pressed, the fan 14, ventilation system 62, variable timer 36, and sound generator 20 are activated simultaneously for a period of thirty minutes, as controlled by the variable timer 36. When the privacy switch 32 is pressed again, the sound system 36 is deactivated but the variable timer 36, fan 14, and ventilation system 62 continue to run for the remainder of the time allotted by the variable timer 36. When the thirty minutes set by the variable timer 36 expires, the fan 14 and ventilation system 62 turn off, as does the sound system 36 if it was not previously deactivated.

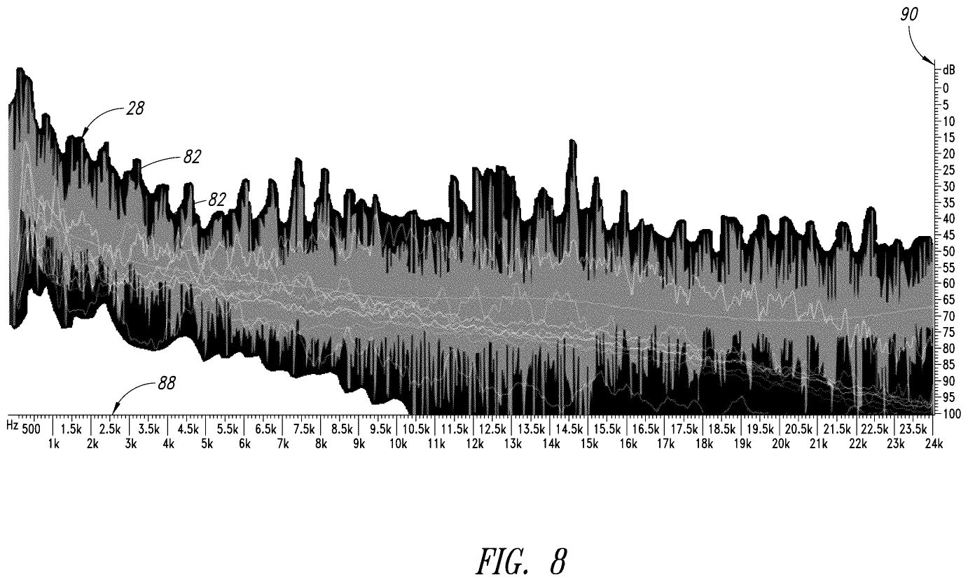

The artificial sound 28 created by the sound generator 20 is a custom brown noise designed to substantially mask the noises 82 associated with use of a toilet 64. Referring to FIG. 8, shown therein is a profile of the artificial sounds 28 produced by the sound generator 20 as well as profiles of the noises 82 commonly associated with use of a bathroom. The frequencies 88 and intensity 90 of the noises 82 associated with bathroom use fall substantially within the range of frequencies 88 and intensity 90 of the artificial sounds 26 produced by the sound generator 20. The result is that the artificial sounds 26 substantially mask the noises 82 in the range of human hearing that are associated with bathroom use. In one implementation, the cover 30 includes a volume control 16 to enable the user to change the volume of the artificial sound 28 generated by the sound generator 20. The volume control 16 may be a pair of buttons, a scroll wheel, or knob placed anywhere on the housing 40. In one implementation, the volume control 16 ranges from 35 to 80 decibels.

As will be readily appreciated from the foregoing, the present disclosure is not a generic approach to sound masking as is currently being done. Rather, the masking of sound using the system and method of the present disclosure is targeted to specifically mask sounds generated in a restroom setting. It may be appreciated that such an approach requires more research and testing than a generic sound masking device. Further, this approach produces an overall quieter effect because the artificial sound 28 is targeted to substantially mask only noises 82 that occur in connection with use of a toilet 64, bidet, or urinal, as demonstrated in FIG. 8. Specifically, the artificial sound 28 embodies substantially the same non-linear relationship between frequency 88 and intensity 90 as the noises 82 associated with the use of a bathroom 80: the intensity 90 increases more rapidly at lower frequencies 88 than it does at higher frequencies 88. Because of this trend, and further because the artificial sound 28 contains constituent audio recordings at a variety of intensities 90, the noises 82 associated with use of a bathroom 64 fall substantially within the curve of the artificial sound 28. The system 60 thus does not produce substantial artificial sound 28 at other frequencies, thus mitigating excess sound “waste” that would otherwise make the system 60 undesirably loud. As can readily be appreciated, previous approaches to sound masking which do not use such a targeted approach result in significant sound waste and an overall louder effect.

To evaluate the frequencies 88 and intensity 90 of noises 82 associated with bathroom use as shown in FIG. 8, the noises 82 were generated from a Sony Sss-xb12 connected to an iPhone. The volume of the speaker was at three levels below the maximum speaker volume. The decibel meter used to measure the noises 82 was located in the center of a closed bathroom door, about 56″ from the ground.

The artificial sound 28, generated by the sound generator 20 and encoded in the set of instructions 26 executable by the processor 22, is a single audio file composed of audio recordings of various scenarios, including running water, and two blade fans, and the recording is taken from directly between the two fans. In some implementations the fans are separated by a distance such as ten feet. In another scenario a ReVent® brand 80 CFM fan was used. The audio file containing the artificial sound 28 contains all of these audio recordings, and it is structured so that the audio recordings are out of phase with each other. The audio file is structured to create a continuous loop of masking sound without a discernible stop or end. In one implementation, the system 60 is structured such that the first speaker 100 emits artificial sound 28 corresponding to the running water sounds encoded in the audio file and the second speaker 102 emits artificial sound 28 corresponding to the fan sounds encoded in the audio file.

Although the disclosure has been described in detail with particular reference to these preferred implementations, other implementations can achieve the same results.

The various implementations described above can be combined to provide further implementations. Aspects of the implementations can be modified, if necessary to employ concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A system for producing artificial sounds to mask noises emanating from the use of a toilet in an interior of a room, the system comprising:
a housing sized and shaped to define an interior and an exterior of the housing; and
a sound system stored within the housing, the sound system comprising a processor, the processor having a memory that has stored therein a set of instructions executable by the processor to generate a sound structured to mask frequencies of noise associated with use of the toilet.

2. The system of claim 1 further comprising a cover that forms a wall of the housing, and a switch that can be toggled by a user to activate the sound system of claim 1.

3. The system of claim 1 further comprising at least one opening in the cover sized and shaped to enable the sound to be emitted from the housing.

4. The system of claim 1 wherein the processor includes a variable timer structured to control the duration of the sound emitted from the sound system, the variable timer adapted to allow the user to select the duration of the sound.

5. The system of claim 1 wherein the sound generated by the processor is structured to mask the noises emanating from the use of the toilet in the range of human hearing.

6. The system of claim 1 wherein the sound generated by the processor is composed of a variety of frequencies that include the frequencies of noise associated with the use of the toilet such that the sound substantially masks the noise associated with the use of the toilet.

7. The system of claim 2 further comprising a ventilation system including a fan inside a fan box, wherein the cover further comprises a fan switch adjacent to the switch, the fan switch capable of being toggled by a user to selectively activate the ventilation system.

8. The system of claim 7 wherein the switch can be toggled by a user to simultaneously activate the ventilation system, fan, and sound system.

9. A system for producing artificial sounds to mask noises emanating from use of a toilet in a bathroom having a wall and a ceiling, the system comprising:
a housing structured to mount to the wall of the bathroom;
means for storing a set of instructions, the storing means contained in the housing; and
means for producing sound contained in the housing and coupled to the storing means, the sound producing means structured to generate a sound that is capable of substantially masking frequencies of noise associated with use of the toilet.

10. A device for producing artificial sounds to mask noises associated with use of a toilet located in an interior of a room having a wall, the device comprising:
a housing sized and shaped to be mounted on or within the wall;
an interior of the housing being formed by at least five housing walls and a cover, the cover sized and shaped to releasably engage with the housing;
a switch mounted in the housing;
a sound system located within the housing and coupled to the switch, the sound system adapted to produce a sound capable of substantially masking the noises associated with use of the toilet in the range of human hearing; and
at least one opening formed in the cover that communicates with the interior of the housing and the interior of the room to allow the sound to be emitted from the housing.

11. A ventilation system for ventilating a room having a toilet, the ventilation system comprising:
means for ventilating the room; and
a device for producing artificial sounds to mask noises associated with use of a toilet located in an interior of a room having a wall, the device comprising:
a housing sized and shaped to be mounted on or within the wall;
an interior of the housing being formed by at least five housing walls and a cover, the cover sized and shaped to releasably engage with the housing;
a switch mounted in the housing that can be toggled by a user to activate the ventilation system;
a sound system located within the housing and coupled to the switch, the sound system adapted to produce a sound capable of substantially masking the noises associated with use of the toilet in the range of human hearing; and
at least one opening formed in the cover that communicates with the interior of the housing and the interior of the room to allow the sound to be emitted from the housing.

12. The ventilation system of claim 11 wherein the system is further adapted to only produce sound comprised of frequencies that substantially mask the noises associated with the use of the toilet and that does not produce substantial sound at other frequencies.

13. The ventilation system of claim 11 further comprising a fan switch adjacent to the switch, wherein the fan switch can be toggled by a user to activate only the means for ventilating the room but not the device for producing artificial sounds.

14. A ventilation system for ventilating a room having a toilet, the ventilation system comprising:
a means for ventilating the room; and
a system for producing artificial sounds to mask noises associated with use of a toilet located in a room having a wall, the system comprising:
a housing sized and shaped to be mounted on or within the wall;
an interior of the housing being formed by at least five housing walls and a cover, the cover sized and shaped to releasably engage with the housing;
a switch mounted in the housing that can be toggled by a user to activate the ventilation system;
a sound system located within the housing and coupled to the switch, the sound system having a processor with a memory that stores a set of instructions executable by the processor to produce sounds capable of substantially masking the noises associated with use of the toilet in the range of human hearing; and
at least one speaker located within the means for ventilating the room and coupled to the sound system to amplify the sound encoded by the set of instructions.
